(19) United States
(12) Patent Application Publication
(10) Pub. No.: US 2024/0073486 A1
(43) Pub. Date: Feb. 29, 2024

(54) VIDEO CONTENT PERSONALIZATION BASED ON VIEWER DATA

(71) Applicants: Peter Philip Myron, New Braunfels, TX (US); Michael John Mitchell, North Bend, WA (US)

(72) Inventors: Peter Philip Myron, New Braunfels, TX (US); Michael John Mitchell, North Bend, WA (US)

(21) Appl. No.: 17/899,388

(22) Filed: Aug. 30, 2022

(51) Int. Cl. H04N 21/485

(52) U.S. Cl. CPC H04N 21/485

(57) ABSTRACT

Systems and methods are provided for personalizing video content using information associated with a viewer of the video content. An indication is received from a host device that dynamic user background replacement is to be used for the video content. An indication is then received of one or more aspects of the video content to be personalized. Potential viewers of the video content are identified. Once identified, a database is queried for personalized information associated with a first viewer of the potential viewers of the video content. Based on the personalized information associated with the first viewer, an original video content version of the video content is modified to generate a first video content version of the video content.

### SUMMARY

The present disclosure is directed, in part, to creating a customized version of video content based on personalized information for a particular viewer of the video content. Presently, a user of a computing device creating video content (e.g., presenter of video content) is able to personalize the video content (e.g., virtual background, lighting), but that personalization is based on the presenter's input/information. Instead, aspects provided herein use the viewer's personalized information (e.g., metadata associated with the viewer) to personalize video content that is meaningful to the viewer. For example, the video could be a political video, a training video, a corporate video, a live video stream, etc.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

Aspects of the present disclosure are described in detail herein with reference to the attached figures, which are intended to be exemplary and non-limiting, wherein:

FIG. 1 depicts a diagram of an exemplary computing environment suitable for use in implementations of the present disclosure;

FIGS. 2a-2c depict diagrams of exemplary computing environments based on a location of the personalization agent, according to various aspects herein;

FIG. 3 depicts a flow diagram of personalizing video content using information associated with a viewer of the video content, in accordance with aspects herein;

FIG. 4 depicts a flow diagram of personalizing video content using information associated with a viewer of the video content, in accordance with aspects herein; and

FIG. 5 depicts an exemplary computing environment suitable for use in implementations of the present disclosure.

### DETAILED DESCRIPTION

The subject matter of aspects of the present disclosure is described with specificity herein to meet statutory requirements. However, the description itself is not intended to limit the scope of this patent. Rather, the inventors have contemplated that the claimed subject matter might also be embodied in other ways, such as to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described. Each method described herein may comprise a computing process that may be performed using any combination of hardware, firmware, and/or software. For instance, various functions may be carried out by a processor executing instructions stored in memory. The methods may also be embodied as computer-useable instructions stored on computer storage media. The methods may be provided by a stand-alone computer application, a service or hosted service (stand-alone or in combination with another hosted service), or a plug-in to another product, to name a few.

Aspects of the present disclosure relate to technology for improving electronic computing technology and enhanced computing services for a user, based on user data associated with application data corresponding to a computer application. In particular, the solutions provided herein include technologies to customize video content based on a viewer's preferences, interests, metadata, recent searches, etc. This customization can take place on a network server, or at the host or viewer's computing device. As used herein, video content may be any content format that features or includes video. Common forms of video content include vlogs, animated GIFs, live videos, previously-recorded videos, customer testimonials, recorded presentations, training materials, and webinars.

By way of background, video content can be customized or personalized based on many types of information. Currently, when a host of video content (e.g., presenter) is generating or otherwise providing the video content to viewers, the viewers are able to see the video content as it is from the host's computing device. In some instances, the host may customize the video content based on the host's customized selections, such as lighting, virtual backgrounds, etc. But this does not allow for personalization based on the viewer's preferences, medical conditions, or other needs or interests. In aspects herein, video content is personalized based on information associated with the viewer. For instance, if the viewer likes a particular college, sports team, color, lighting, brand, politics, etc., that information can be used to customize a video that is meant to be viewed by that particular viewer. Each viewer of a particular video content could have a personalized experience when viewing the video content, even though the viewers are watching the same original content. Said in a different way, the video content can be personalized without any need for the host/source to choose/influence the customizations, or even be aware of what the customizations/personalizations are. The video content could be pre-recorded, or could be live streamed in real-time.

The modification of video content could take place at one or more different locations, such as on the host device, the viewer device, or on the network. As will be described herein, a personalization agent may be located in one of many locations. Regardless of its location, the personalization agent is generally responsible for identifying viewers of the video content, querying a database to ascertain personalization information associated with the viewers, and then modifying the original video content based on that personalized information. The database that is queried for viewer metadata could be associated with the network (e.g., a telecommunications network) or could be associated with the viewer's computer. So the personalization agent may query the network, or the viewer's computer to get personalized information associated with the viewer, or both.

Any type of video capturing device, system, website, or application could be used to carry out the aspects provided herein. For example, there are many commercial video conferencing systems that can be used to provide video content, and could also be used to make modifications to the video content based on the viewer's personalized information. The video conferencing system could be located on the host device and/or the viewer device. As such, these video conferencing systems may not only capture video, but may also modify the video based on viewer preferences/metadata/needs.

A first aspect of the present disclosure is directed to a method for personalizing video content using information associated with a viewer of the video content. The method includes receiving an indication from a host device that dynamic user background replacement is to be used for the video content, receiving an indication of one or more aspects of the first video content version to be personalized, and identifying one or more potential viewers of the first video content version. Further, the method includes querying a database for personalized information associated with a first viewer of the one or more potential viewers of the particular video content, and based on the personalized information associated with the first viewer, modifying an original video content version to generate a first video content version.

A second aspect of the present disclosure is directed to a system for personalizing video content using information associated with a viewer of the video content. The system includes one or more processors and one or more computer storage hardware devices storing computer-usable instructions that, when used by the one or more processors, cause the one or more processors to perform steps. The steps include receiving an indication from a host device that dynamic user background replacement is to be used for the video content, receiving an indication of one or more aspects of the video content to be personalized, and identifying one or more potential viewers of the video content. Further, the steps include querying a database for personalized information associated with a first viewer of the one or more potential viewers of the particular video content, and based on the personalized information associated with the first viewer, modifying an original video content version to generate a first video content version.

According to another aspect of the technology described herein, a method is provided for personalizing video content using information associated with a viewer of the video content. The method includes requesting personalized information associated with a first viewer of the video content, receiving the personalized information associated with the first viewer, and based on the personalized information associated with the first viewer, modifying an original video content version to generate a first video content version.

Throughout this disclosure, several acronyms and shorthand notations are used to aid the understanding of certain concepts pertaining to the associated system and services. These acronyms and shorthand notations are intended to help provide an easy methodology of communicating the ideas expressed herein and are not meant to limit the scope of aspects herein.

Embodiments herein may be embodied as, among other things: a method, system, or set of instructions embodied on one or more computer-readable media. Computer-readable media include both volatile and nonvolatile media, removable and nonremovable media, and contemplate media readable by a database, a switch, and various other network devices. Computer-readable media includes media implemented in any way for storing information. Examples of stored information include computer-useable instructions, data structures, program circuitry, and other data representations. Media examples include RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These technologies can store data momentarily, temporarily, or permanently. Embodiments may take the form of a hardware embodiment, or an embodiment combining software and hardware. Some embodiments may take the form of a computer-program product that includes computer-useable or computer-executable instructions embodied on one or more computer-readable media.

“Computer-readable media” may be any available media and may include volatile and nonvolatile media, as well as removable and non-removable media. By way of example, and not limitation, computer-readable media may include computer storage media and communication media.

“Computer storage media” may include, without limitation, volatile and nonvolatile media, as well as removable and non-removable media, implemented in any method or technology for storage of information, such as computer-readable instructions, data structures, program circuitry, or other data. In this regard, computer storage media may include, but is not limited to, Random-Access Memory (RAM), Read-Only Memory (ROM), Electrically Erasable Programmable Read-Only Memory (EEPROM), flash memory or other memory technology, CD-ROM, digital versatile disks (DVDs) or other optical disk storage, magnetic cassettes, magnetic tape, magnetic disk storage, or other magnetic storage devices, or any other medium which may be used to store the desired information and which may be accessed by the computing device 700 shown in FIG. 7. Computer storage media does not comprise a signal per se.

“Communication media” may include, without limitation, computer-readable instructions, data structures, program circuitry, or other data in a modulated data signal, such as a carrier wave or other transport mechanism, and may include any information delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, radio frequency (RF), infrared, and other wireless media. Combinations of any of the above also may be included within the scope of computer-readable media.

A “network” refers to a network comprised of wireless and wired components that provide wireless communications service coverage to one or more user equipment (UE). The network may comprise one or more base stations, one or more cell sites (i.e., managed by a base station), one or more cell towers (e.g., having an antenna) associated with each base station or cell site, a gateway, a backhaul server that connects two or more base stations, a database, a power supply, sensors, and other components not discussed herein, in various embodiments.

The terms “base station” and “cell site” may be used interchangeably herein to refer to a defined wireless communications coverage area (e.g., a geographic area) serviced by a base station. It will be understood that one base station may control one cell site or alternatively, one base station may control multiple cell sites. As discussed herein, a base station is deployed in the network to control and facilitate, via one or more antenna arrays, the broadcast, transmission, synchronization, and receipt of one or more wireless signals in order to communicate with, verify, authenticate, and provide wireless communications service coverage to one or more UE that request to join and/or are connected to a network.

An “access point” may refer to hardware, software, devices, or other components at a base station, cell site, and/or cell tower having an antenna, an antenna array, a radio, a transceiver, and/or a controller. Generally, an access point may communicate directly with user equipment according to one or more access technologies (e.g., 3G, 4G, LTE, 5G, mMIMO (massive multiple-input/multiple-output)) as discussed herein.

The terms “user equipment,” “UE,” and/or “user device” are used interchangeably to refer to a device employed by an end-user that communicates using a network. UE generally includes one or more antenna coupled to a radio for exchanging (e.g., transmitting and receiving) transmissions with a nearby base station, via an antenna array of the base station. In embodiments, UE may take on any variety of devices, such as a personal computer, a laptop computer, a tablet, a netbook, a mobile phone, a smart phone, a personal digital assistant, a wearable device, a fitness tracker, or any other device capable of communicating using one or more resources of the network. UE may include components such as software and hardware, a processor, a memory, a display component, a power supply or power source, a speaker, a touch-input component, a keyboard, and the like. In embodiments, some of the UE discussed herein may include current UE capable of using 5G and having backward compatibility with prior access technologies (e.g., Long-Term Evolution (LTE)), current UE capable of using 5G and lacking backward compatibility with prior access technologies, and legacy UE that is not capable of using 5G.

Additionally, it will be understood that terms such as “first,” “second,” and “third” are used herein for the purposes of clarity in distinguishing between elements or features, but the terms are not used herein to import, imply, or otherwise limit the relevance, importance, quantity, technological functions, sequence, order, and/or operations of any element or feature unless specifically and explicitly stated as such. Along similar lines, certain UE are described herein as being “priority” UE and non-priority UE, but it should be understood that in certain implementations UE may be distinguished from other UEs based on any other different or additional features or categorizations (e.g., computing capabilities, subscription type, and the like).

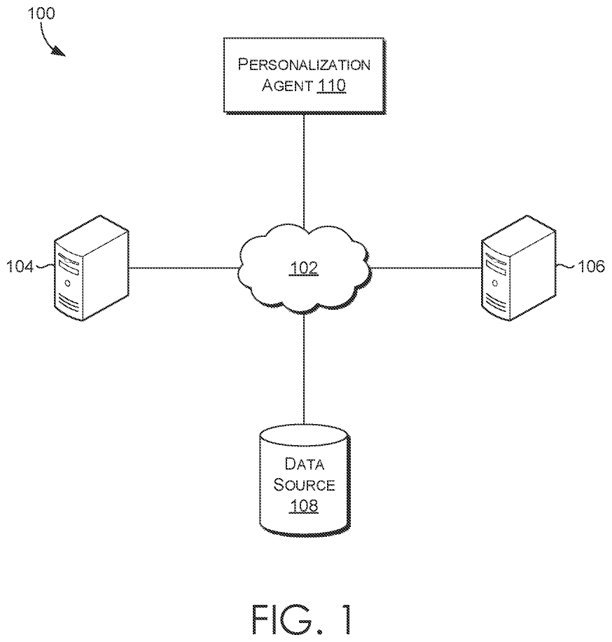

Turning now to FIG. 1, FIG. 1 depicts a diagram of an exemplary network environment 100 suitable for use in implementations of the present disclosure. Such a network environment is illustrated and designated generally as network environment 100. Network environment 100 is but one example of a suitable network environment and is not intended to suggest any limitation as to the scope of use or functionality of the invention. Neither should the network environment be interpreted as having any dependency or requirement relating to any one or combination of components illustrated.

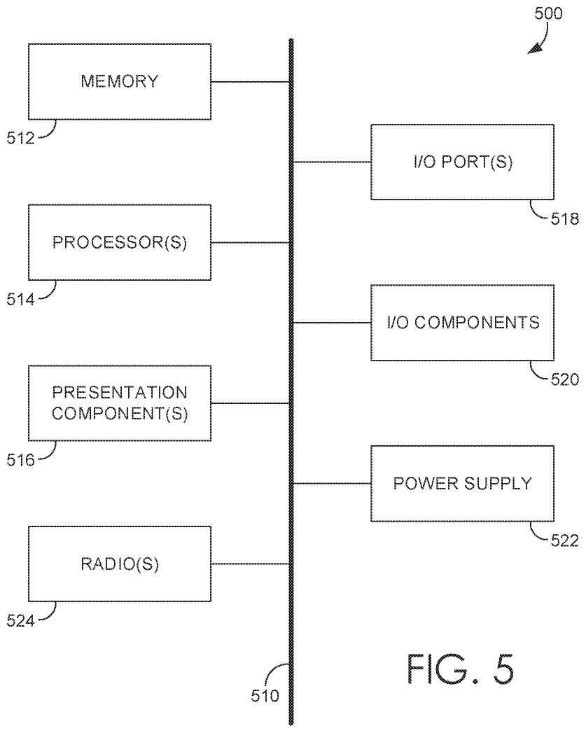

Network environment 100 provides service to one or more user devices, such as exemplary user devices 104 and 106. User device 104 is a host device, which is a device that is hosting and/or presenting and/or recording the video content. The host device could be generating video content, such as a live recording in real-time, or could be playing the content that was pre-recorded. User device 106 is a viewer device, which is the device presenting the video content to a viewer. In some embodiments, the network environment 100 may be a telecommunication network (e.g., a telecommunication network such as, but not limited to, a wireless telecommunication network), or portion thereof. In other aspects, network environment 100 is not a telecommunication network. The network environment 100 may include one or more devices and components, such as base stations, servers, switches, relays, amplifiers, databases, nodes, etc. which are not shown so as to not confuse other aspects of the present disclosure. (Example components and devices are discussed below with respect to FIG. 5.) Those devices and components may provide connectivity in a variety of implementations. In addition, the network environment 100 may be utilized in a variety of manners, such as a single network, multiple networks, or as a network of networks, but, ultimately, is shown as simplified as possible to avoid the risk of confusing other aspects of the present disclosure.

The network environment 100, when it is a telecommunications network, may include or otherwise may be accessible through a node (not shown). Node may include one or more antennae, base transmitter stations, radios, transmitter/receivers, digital signal processors, control electronics, GPS equipment, power cabinets or power supply, base stations, charging stations, and the like. In this manner, node may provide a communication link between the one or more user devices 104 and 106 and any other components, systems, equipment, and/or devices of the network environment 100 (e.g., the beam management system). The base station and/or a computing device (e.g., whether local or remote) associated with the base station may manage or otherwise control the operations of components of the node. Example components that may control the operations of components of node are discussed below with respect to FIG. 5.

The node may include a Next Generation Node B (e.g., gNodeB or gNB) or any other suitable node structured to communicatively couple to the one or more user devices 104 and 106. Node may correspond to one or more frequency bands. A frequency is the number of times per second that a radio wave completes a cycle. The frequency band may include a frequency range (e.g., a lower frequency and an upper frequency) within which the user device(s) may connect to the network environment such as, but not limited to, a telecommunication network or a portion thereof. The frequency range may be measured by the wavelength in the range or any other suitable wave properties.

In some embodiments, the one or more user devices 104 and 106 may take the form of a wireless or mobile device capable of communication via the network environment 100. For example, the one or more user devices 104 and 106 may take the form of a mobile device capable of communication via a telecommunication network such as, but not limited to, a wireless telecommunication network. In this regard, the one or more user devices 104 and 106 may be any mobile computing device that communicates by way of a network, for example, a 3G, CDMA, 4G, LTE, WiMAX, 5G, 6G or any other type of network. The network environment 100 may include any communication network, shown as network 102, providing voice and/or data service(s), such as, for example, a 1× circuit voice, a 3G network (e.g., Code Division Multiple Access (CDMA), CDMA 2000, WCDMA, Global System for Mobiles (GSM), Universal Mobile Telecommunications System (UMTS), a 4G network (LTE, Worldwide Interoperability for Microwave Access (WiMAX), High-Speed Downlink Packet Access (HSDPA)), or a 5G network.

When Network 102 is not a telecommunications network, Network 102 may include, without limitation, one or more local area networks (LANs) and/or wide area networks (WANs). In exemplary implementations, network 102 comprises the Internet and/or a cellular network, amongst any of a variety of possible public and/or private networks. It should be understood that any number of user devices, servers, and data sources may be employed within operating environment 100 within the scope of the present disclosure. Each may comprise a single device or multiple devices cooperating in a distributed environment. For instance, the personalization agent 110 and data source 108 may be provided via multiple devices arranged in a distributed environment that collectively provide the functionality described herein. Additionally, other components not shown may also be included within the distributed environment. Network 102 may include a server that can comprise server-side software designed to work in conjunction with client-side software on user devices 104 and 106 so as to implement any combination of the features and functionalities discussed in the present disclosure.

User devices 104 and 106 of FIG. 1 may comprise any type of computing device capable of use by a user. For example, in one embodiment, user devices provided herein may be the type of computing device described in relation to FIG. 5 herein. The user device may or may not comprise a radio and antennae. By way of example and not limitation, a user device may be embodied as a personal computer (PC), a laptop computer, a cellular or mobile device, a smartphone, a smart speaker, a tablet computer, a smart watch, a virtual reality (VR) or augmented reality (AR) device or headset, a wearable computer, a personal digital assistant (PDA) device, a music player or an MP3 player, a global positioning system (GPS) or device, a video player, a handheld communications device, a gaming device or system, an entertainment system, a vehicle computer system, an embedded system controller, a camera, a remote control, an appliance, a consumer electronic device, a workstation, any other suitable computer device, or any combination of these delineated devices.

Data source 108 may comprise data sources and/or data systems, which are configured to make data available to any of the various constituents of operating environment 100. For instance, in one embodiment, one or more data sources, such as data source 108 provide access (or make available for accessing) to a personalization agent 110 user data (for example, associated with application data corresponding to a computer application), which corresponds to a viewer of the video content. Data source 108 may be discrete from user devices 104 and 106 and personalization agent 110, or may be incorporated and/or integrated into at least one of those components. Data source 108 may include personalization information, such as any metadata associated with a viewer of the video content, which could include, for exemplary purposes only and not limitation, products or services the user has indicated as being of interest (e.g., based on Internet searches, interactions with websites and/or social media, groups on social media in which the user as indicated an interest), lighting preferences, color sensitivities, color blindness indications, color preferences, political affiliations, athletic team preferences, sport preferences, college preferences, or the like. Data source 108 could be located on network 102.

As shown in FIG. 1, user device 104 may be a host device and user device 106 may be a viewer device. As mentioned, a personalization agent may be responsible for querying for personalization information of a viewer, and/or may be responsible for modifying original video content for one or more viewers of the video content. The personalization agent would be equipped with the software needed to make the personalization modifications, such as changing color, lighting, content, etc. of the original video content. In one aspect herein, the personalization agent may be located on the host device, or may be located on the viewer device. In yet another aspect, the personalization agent is located on the network. Other network components, while may be used in processes described herein, are not shown in FIG. 1 for purposes of clarity.

In some implementations, node 102 is configured to communicate with user devices, such as the one or more user devices 104 and 106, and other devices that are located within the geographical area, or cell, covered by the one or more antennae of node 102. In the case of a telecommunications network, node 102 may include one or more base stations, nodes, base transmitter stations, radios, antennae, antenna arrays, power amplifiers, transmitters/receivers, digital signal processors, control electronics, GPS equipment, and the like. In one aspect, node 102 is a gNodeB, while in another aspect, node 102 is an eNodeB. In particular, the one or more user devices 104 and 106 may communicate with node 102 according to any of one or more communication protocols, in order to access the network.

Having described the network environment 100 and components operating therein, it will be understood by a person having ordinary skill in the art that the network environment 100 is but one example of a suitable network and is not intended to limit the scope of use or functionality of aspects described herein. Similarly, the network environment 100 should not be interpreted as imputing any dependency and/or any requirements with regard to each component and combination(s) of components illustrated in FIG. 1. It will be appreciated by a person having ordinary skill in the art that the number, interactions, and physical location of components illustrated in FIG. 1 are examples, as other methods, hardware, software, components, and devices for establishing one or more communication links between the various components may be utilized in implementations of the present disclosure. It will be understood to a person having ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1, it will be appreciated that some aspects may include a plurality of devices and/or components such that FIG. 1 should not be considered as limiting the quantity of any device and/or component.

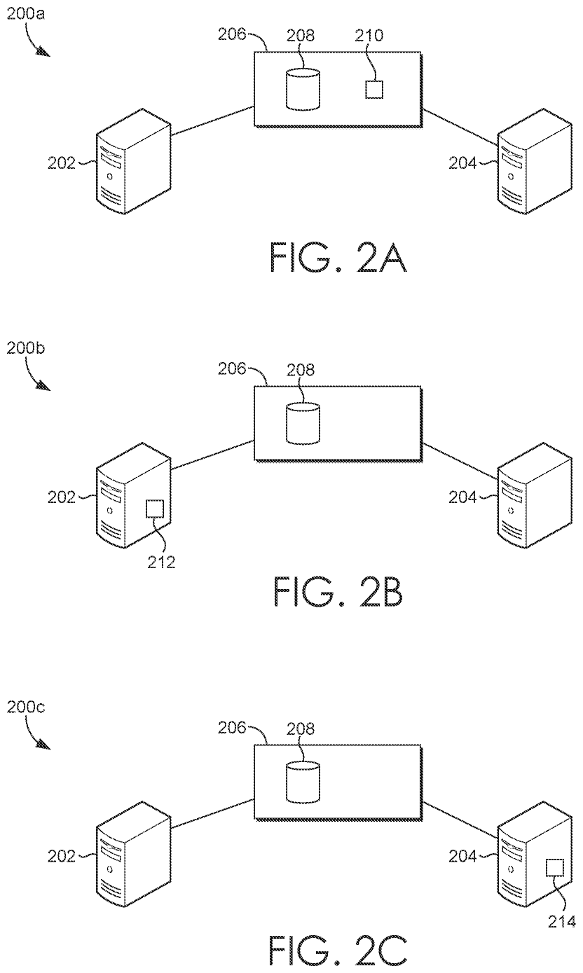

FIGS. 2A-2C illustrate diagrams of exemplary computing environments based on a location of the personalization agent. FIG. 2A illustrates a computing environment 200a with a host device 202, a viewer device 204, and a server 206. The server could be part of a network, such as network 102 of FIG. 1. Server 206 may include a data source 208. In the exemplary aspect of FIG. 2A, the personalization agent 210 is shown as being associated with the server 206 instead of being located on either the host device 202 or the viewer device 204. As such, any customizations made to video content are made by the server 206.

FIG. 2B illustrates a computing environment 200b with a host device 202, a viewer device 204, and a server 206. The server could be part of a network, such as network 102 of FIG. 1. Server 206 may include a data source 208. In the exemplary aspect of FIG. 2B, the personalization agent 212 is shown as being on the host device 202, instead of being located on either the server 206 or the viewer device 204. As such, any customizations made to video content are made by the host device 202.

FIG. 2C illustrates a computing environment 200c with a host device 202, a viewer device 204, and a server 206. The server could be part of a network, such as network 102 of FIG. 1. Server 206 may include a data source 208. In the exemplary aspect of FIG. 2C, the personalization agent 214 is shown as being on the viewer device 202, instead of being located on either the server 206 or the host device 202. As such, any customizations made to video content are made by the viewer device 204.

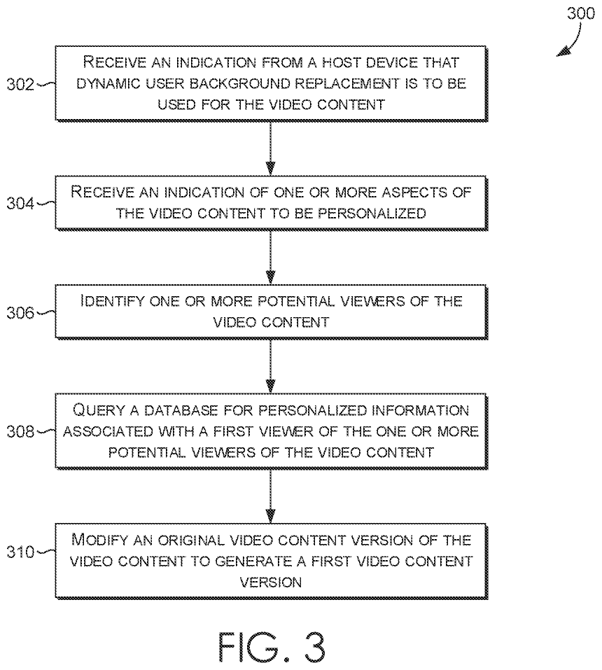

FIG. 3 depicts a flow diagram of an exemplary method 300 for personalizing video content using information associated with a viewer of the video content, in accordance with aspects herein. At block 302, an indication is received from a host device that dynamic user background replacement is to be used for the video content. The video content could be pre-recorded, or could be live streamed in real-time. At block 304, an indication is received of one or more aspects of the video content that are to be personalized. In one aspect, the one or more aspects to be personalized may include video lighting, object customization, or facial/body modifications (e.g., cartoon characters). For example, an object customization could be a cup, mug, flag, or banner in the video content that could be customized with a favorite college or professional sports team of the viewer. Or, a facial/body modification could be the use of a cartoon figure in place of the person's head/body in the video content. In some aspects, the viewer could have a form of color blindness, and thus the colors in the video could be modified to be those colors that can be seen by the viewer. Or the viewer could have low vision/color vision or poor vision, which could prompt the personalization agent making the modifications to modify coloring and/or change size of font in the video content. The preceding examples are provided not for limitation, but for exemplary purposes only.

One or more potential viewers of the video content are identified at block 306. At block 308, a database is queried for personalized information associated with a first viewer of the one or more potential viewers of the video content. At block 310, the original content version is modified to generate a first video content version using the personalized information associated with the first viewer. The first video content version may then be accessible to a computing device associated with the first viewer. For instance, this version may be communicated from the location in which it was personalized for the first viewer, to a computer device associated with the first viewer. In one aspect, the modification of the video content is performed by a viewer device, such as the first viewer's computing device. In another aspect, the modification can be performed by the host device, or even by a component on the network.

In another aspect, a database is queried for personalized information associated with a second viewer of the video content. Based on this personalized information, the original video content version is modified to generate a second video content version. The second video content is then caused to be accessible to a computing device associated with the second viewer. In aspects, the first viewer is different from the second viewer, and thus the first video content version is different than the second video content version.

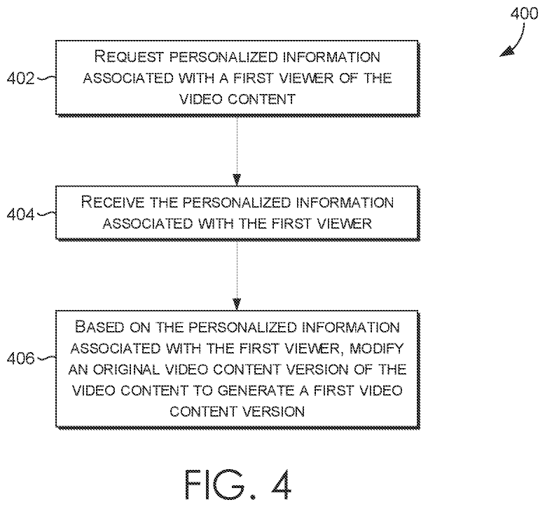

Turning to FIG. 4, a flow diagram is depicted of another exemplary method 400 for personalizing video content using information associated with a viewer of the video content, in accordance with aspects herein. At block 402, personalized information associated with a first viewer of video content is requested from a database containing information associated with the viewer of the video content. The personalized information associated with the first viewer is received at block 404. At block 406, based on the personalized information, an original video content version of the video content is modified to generate a first video content version.

Referring to FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the invention. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, computing device 500 includes bus 510 that directly or indirectly couples the following devices: memory 512, one or more processors 514, one or more presentation components 516, input/output (I/O) ports 518, I/O components 520, power supply 522, and radio 524. Bus 510 represents what may be one or more busses (such as an address bus, data bus, or combination thereof). Although the devices of FIG. 5 are shown with lines for the sake of clarity, in reality, delineating various components is not so clear. For example, one may consider a presentation component such as a display device to be one of I/O components 520. Also, processors, such as one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media does not comprise a propagated data signal.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 512 includes computer-storage media in the form of volatile and/or nonvolatile memory. Memory 512 may be removable, nonremovable, or a combination thereof. Exemplary memory includes solid-state memory, hard drives, optical-disc drives, etc. Computing device 500 includes one or more processors 514 that read data from various entities such as bus 510, memory 512 or I/O components 520. One or more presentation components 516 presents data indications to a person or other device. Exemplary one or more presentation components 516 include a display device, speaker, printing component, vibrating component, etc. I/O ports 518 allow computing device 500 to be logically coupled to other devices including I/O components 520, some of which may be built in computing device 500. Illustrative I/O components 520 include a microphone, joystick, game pad, satellite dish, scanner, printer, wireless device, etc.

Radio 524 represents a radio that facilitates communication with a wireless telecommunications network. Illustrative wireless telecommunications technologies include CDMA, GPRS, TDMA, GSM, and the like. Radio 524 might additionally or alternatively facilitate other types of wireless communications including Wi-Fi, WiMAX, LTE, or other VoIP communications. As can be appreciated, in various embodiments, radio 524 can be configured to support multiple technologies and/or multiple radios can be utilized to support multiple technologies. A wireless telecommunications network might include an array of devices, which are not shown so as to not obscure more relevant aspects of the invention. Components such as a base station, a communications tower, or even access points (as well as other components) can provide wireless connectivity in some embodiments.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A method for personalizing video content using information associated with a viewer of the video content, the method comprising:
receiving an indication from a host device that dynamic user background replacement is to be used for the video content;
receiving an indication of one or more aspects of the video content to be personalized;
identifying one or more potential viewers of the video content;
querying a database for personalized information associated with a first viewer of the one or more potential viewers of the video content; and
based on the personalized information associated with the first viewer, modifying an original video content version of the video content to generate a first video content version of the video content.

2. The method of claim 1, further comprising causing the first video content version to be accessible to a computing device associated with the first viewer.

3. The method of claim 1, further comprising querying a database for personalized information associated with a second viewer of the one or more potential viewers of the video content; and
based on the personalized information associated with the second viewer, modifying the original video content version to generate a second video content version.

4. The method of claim 1, further comprising causing the second video content version to be accessible to a computing device associated with the second viewer.

5. The method of claim 3, wherein the first video content version is different than the second video content version.

6. The method of claim 1, wherein the one or more aspects of the video content to be personalized comprise at least one of video lighting, object customization, or facial/body modifications.

7. The method of claim 6, wherein the object customization comprises utilizing the personalized information to add content to an object in the video content.

8. The method of claim 1, wherein the modifying the original video content version is done without input from a user of the host computer.

9. The method of claim 1, wherein the indication of the one or more aspects of the video content to be personalized is received from a user of the host computer.

10. A system for personalizing video content using information associated with a viewer of the video content, the system comprising:
one or more processors; and
one or more computer storage hardware devices storing computer-usable instructions that, when used by the one or more processors, cause the one or more processors to:
receiving an indication from a host device that dynamic user background replacement is to be used for the video content;
receiving an indication of one or more aspects of the video content to be personalized;
identifying one or more potential viewers of the video content;
querying a database for personalized information associated with a first viewer of the one or more potential viewers of the video content; and
based on the personalized information associated with the first viewer, modifying an original video content version of the video content to generate a first video content version.

11. The system of claim 10, wherein the one or more aspects of the video content to be personalized comprise at least one of video lighting, object customization, or facial/body modifications.

12. The system of claim 10, wherein the modifying the original video content version to generate the first video content version is performed without input from a user of the host device.

13. The system of claim 10, wherein the modifying the original video content version to generate the first video content version is performed by a computing device corresponding to the first viewer.

14. The system of claim 10, wherein the modifying the original video content version to generate the first video content version is done by a server that is not associated with the host device or a computing device associated with the first viewer.

15. The system of claim 10, further comprising:
querying a database for personalized information associated with a second viewer of the one or more potential viewers of the video content; and
based on the personalized information associated with the second viewer, modifying the original video content version to generate a second video content version.

16. A method for personalizing video content using information associated with a viewer of the video content, the method comprising:
requesting personalized information associated with a first viewer of the video content;
receiving the personalized information associated with the first viewer; and
based on the personalized information associated with the first viewer, modifying an original video content version of the video content to generate a first video content version.

17. The method of claim 16, causing the first video content version to be accessible to a computing device associated with the first viewer.

18. The method of claim 16, wherein requesting the personalized information associated with the first viewer of the video content further comprises querying a database in a wireless communication network.

19. The method of claim 16, further comprising:
requesting personalized information associated with a second viewer of the video content;
receiving the personalized information associated with the second viewer; and
based on the personalized information associated with the second viewer, modifying the original video content version to generate a second video content version.

20. The method of claim 16, wherein the video content is a live stream video.
